(19) United States
(12) Patent Application Publication
(10) Pub. No.: US 2007/0136096 A1
(43) Pub. Date: Jun. 14, 2007

(54) SYSTEMS AND METHODS FOR MAINTAINING AND ACCESSING MEDICAL INFORMATION

(76) Inventors: Lorna Ikel Okalebo, Cheltenham (GB); Stephen Opiyo, Lincoln, NE (US)

Correspondence Address: MORRISS O''BRYANT COMPAGNI, P.C., 734 EAST 200 SOUTH, SALT LAKE CITY, UT, 84102, US

(21) Appl. No.: 11/609,505

(22) Filed: Dec. 12, 2006

Related U.S. Application Data
(60) Provisional application No. 60/749,375, filed on Dec. 12, 2005.

(51) Int. Cl. G06Q 10/00

(52) U.S. Cl. 705/2

(57) ABSTRACT

Methods and systems related to computer based systems for maintaining and updating a database for medical and other service providers. A computer system serving as a network server makes a relational database available to users, such as medical practitioners, nurses, and social workers. Users log in over a network connection from a remote workstation and are able to access the database to obtain information on available medical, health, social or community services. Users may update the database in real time as situations change. Use of the database allows practitioners to refer patients to appropriate available services and may allow service providers access to information regarding individuals in need of such services. Coordination among service providers and geographic regions may be based upon information in the database. Analysis of database contents over time may be used to predict future needs or to assist in epidemiological analysis.

### CROSS-REFERENCE TO RELATED APPLICATION

This application claims the benefit of U.S. Provisional Application No. 60/749,375, filed Dec. 12, 2005, which is incorporated herein by reference in its entirety.

### TECHNICAL FIELD

The present invention relates generally to systems and methods for maintaining and accessing health care information. More particularly, the present invention relates to systems and methods for providing current medical, health care, and social service information for sharing among appropriate professionals.

### BACKGROUND

Medical professionals, such as Family Practice Doctors or General Practitioners (“GPs”), Nurse Practitioners (“NPs”), and Physician's Assistants (“PAs”) who work out of hours (i.e. between 1830 and 0800 hours) and weekends need easy access to a number of services, such as nursing services, social services, and crisis and critical care services. Often, these practitioners are called upon to see patients who do not necessarily need services from a GP, NP or PA, but need basic nursing service (e.g., dressing wounds or catheterization), access to social services, or crisis or critical care services, such as a home of refuge for an elderly woman who needs personal care support, or access to a women's shelter.

Information regarding access to such ancillary services is often disorganized at best. It often consists of a folder maintained at a central hub with copies distributed to front-line staff (e.g., physicians, GPs, etc.) that contain information on existing community resources, together with a few contact telephone numbers, allowing the practitioner to leave messages for ancillary services to respond to when they are available. Often these files are infrequently updated, and only as often as they are discovered to be out of date.

Additionally, with respect to the individual patients, the information collected and maintained by the ancillary services, such as meals-on-wheels, or community nursing, may simply be unavailable to the practitioner.

A system or method of allowing practitioners to obtain up-to-date information on community, social and ancillary medical services would be an improvement in the art. Such a method or system that also allows nurses, social workers and other allied medical staff to track clinical activity related to their provision of services for certain individuals would similarly constitute an improvement in the art.

### SUMMARY OF THE INVENTION

The present invention includes methods and systems related to a computer based system for maintaining and updating a database for medical and other service providers. A computer system serving as a network server makes a database available to users, such as medical practitioners, nurses, and social workers. Workers log in over a network connection from a remote workstation or PC and are able to access the database to obtain information on available medical, health, social or community services. Users may be able to update the database in real time as situations change. Use of the database allows practitioners to refer patients to appropriate available services and can allow service providers access to information regarding individuals in need of such services. Coordination among service providers and geographic regions may be based upon information in the database. Analysis of the database contents over time may be used to predict future needs for a community or to assist in epidemiological analysis.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the drawings.

FIG. 1 is a diagram illustrating one possible embodiment of a computer based system for maintaining and updating a database for medical and other service providers in accordance with one aspect of the present invention.

FIG. 2 depicts a flowchart illustrating the interactions of several components of one illustrative system for providing access to a system for maintaining and updating a relational database of ancillary medical information, in accordance with the present invention.

### DETAILED DESCRIPTION

The present invention relates to systems and methods for maintaining and providing access to medical and health care information by health care professionals. It will be appreciated by those skilled in the art that the embodiments herein described, while illustrating certain embodiments, are not intended to so limit the invention. Those skilled in the art will also understand that various combinations or modifications of the embodiments presented herein can be made without departing from the scope of the invention. All such alternate embodiments are within the scope of the present invention.

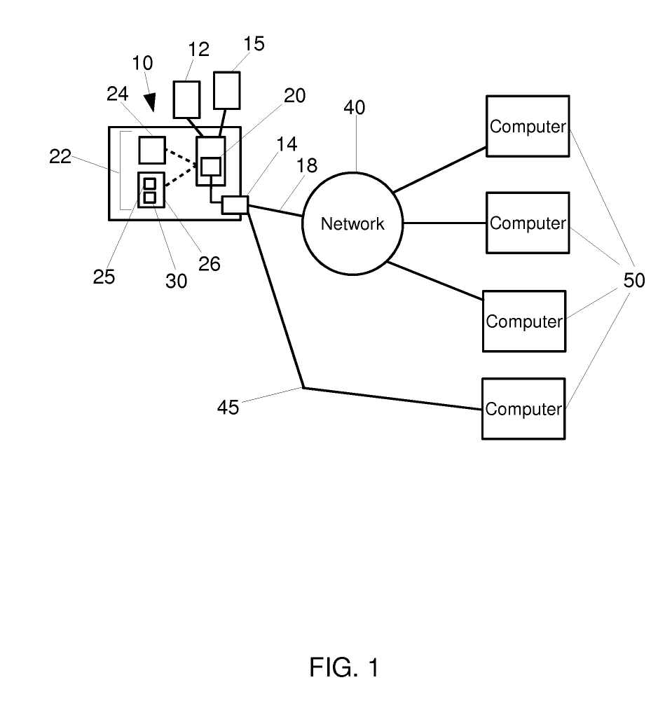

Referring to FIG. 1, one possible embodiment of a computer based system for maintaining and updating a database for medical and other service providers in accordance with the present invention is depicted, including a central computer system 10 for carrying out a portion of the methods and processes of the present invention. It will be appreciated that although central computer system 10 is depicted as a single computer for simplicity, any number of different computers functioning to act as a single system for carrying out the processes or methods described herein may be used and is within the scope of the present invention. Central computer system 10 may include or function as a Web interfacing system (e.g., a Web server) for enabling access and interaction with other devices linked to local and external communication networks (“networks”), including the World Wide Web (the “Internet”), a local area network (LAN), a wide area network (WAN), an intranet, the computer network of an online service, etc. Central computer system 10 optionally may include one or more local displays 15, which may comprise a conventional monitor, a monitor coupled with an integrated display, an integrated display (e.g., an LCD display), or other means for viewing data or processing information. One or more interface modules may also be present to support input and output between a user and the participant tracking computer system 10 through an interface device 12 such as a joystick, keyboard, mouse or data glove. Central computer system 10 may also include a network interface (I/O) 14 for bidirectional data communication through one or more and preferably all of the various networks (LAN, WAN, Internet, etc.) using communication paths or links known in the art, including wireless connections, ethernet, bus line, Fibre Channel, ATM, standard serial connections, and the like.

Still referring to FIG. 1, central computer system 10 may include one or more microprocessors 20 responsible for controlling all aspects of the computer system 10. Thus, microprocessor 20 may be configured to process executable programs and/or communications protocols which are stored in memory 22. Microprocessor 20 is provided with memory 22 in the form of RAM 24 and/or hard disk memory 26 and/or ROM (not shown). As used herein, memory designated for temporarily or permanently storing one or more service provider information protocols on hard disk memory 26 or another data storage device in communication with participant tracking computer system 10 is referred to as service provider relational database 25. Service provider relational database 25 may be configured in any suitable method known to those of ordinary skill in the art, for example as a MS SQL database. Similarly, memory designated for temporarily or permanently storing one or more interfaces generated by or utilized by central computer system 10 on hard disk memory 26 or another data storage device in communication with central computer system 10 is referred to as communication database 30.

In one embodiment of the present invention, central computer system 10 uses microprocessor 20 and the memory stored protocols to exchange data with other devices/users on one or more of the networks via Hyper Text Transfer Protocol (HTTP) and Simple Mail Transfer Protocol (SMTP), although other protocols such as File Transfer Protocol (FTP), Simple Network Management Protocol (SNMP), and Gopher document protocol may also be supported. Webpage-like interfaces with the remote computers 50 may thus be used. Central computer system 10 may further be configured to send and receive HTML formatted files. In addition to being linked to a local area network (LAN) or wide area network (WAN), central computer system 10 may be linked directly to the Internet via network interface 14 and communication links 18 attached thereto, or be capable of linking directly to a remote computer 50 (as will be discussed further herein).

Central computer system 10 will preferably contain executable software programs stored on hard disk 26 related to the operation of a Web server. Hard disk 26 may also contain specific software programs relating to the service provider data management functions, as in service provider relational database 25. Alternatively, a separate hard disk, or other storage device, (not shown) may optionally be provided with the requisite software programs for conducting the processes and methods as described herein.

Central computer system 10 may be able to communicate with remote computers 50. This may be accomplished in any suitable fashion. For example, communication may occur over a network 40, which may include the internet, to which central computer system 10 is in operative communication via network interface 14 and communications link 18. Alternatively, central computer system 10 may directly communicate with a remote computer 50, using a direct connection 45 in operative connection with communications link 18, such as a direct dial connection over telephone lines, or another suitable connection.

It will be appreciated that in addition to freestanding PCs and workstations, a remote computer 50 may be a personal digital assistant (PDAs), or other portable electronic device capable of executing software and establishing a network connection to the central computer system 10. For example, a cell phone incorporating a PDA may be used, or a PDA utilizing Bluetooth or another wireless connection protocol may be used.

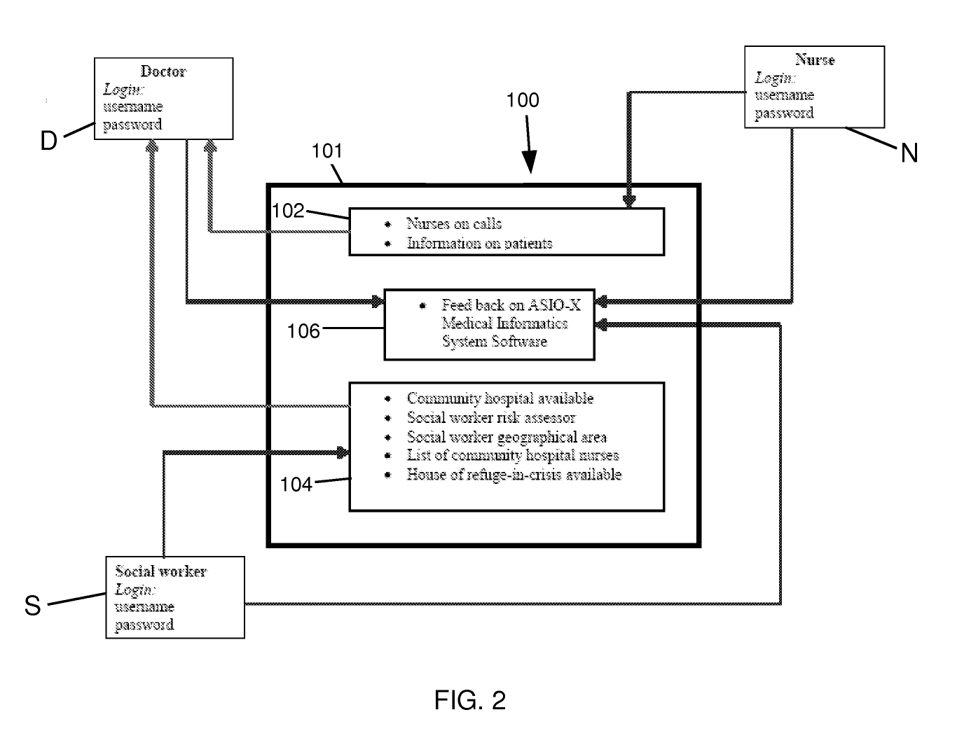

Turning to FIG. 2, a flowchart illustrating the interactions of several components of an illustrative system, generally indicated at 100, for maintaining and updating a relational database of ancillary medical information is depicted. Illustrative interactions of a doctor or other practitioner D, a nurse or other ancillary medical professional N, and a social worker or other social or community service provider S with the system 100 are all depicted.

Embodiments of the present invention, including the embodiment shown in FIG. 2, may be implemented by software running on a suitable computer system 101, such as that depicted in FIG. 1 as central computer system 10, which executes a series of commands contained within the system as lines of software code.

The computer system 101 may be accessed by different individuals involved who are using other freestanding computers, such as individual PCs, or by using individual workstations (which may be remote workstations) in communication with the system 100. It will be appreciated that such freestanding computers may include the remote computers 50, depicted in FIG. 1. In one presently contemplated embodiment, the system 100 is provided on a webserver that may be accessed by registered users using freestanding PCs which make a connection thereto using a direct network connection, a direct dial modem connection, or over the internet using a secure protocol. The electronic transmission of information may be transmitted in accordance with the standards promulgated under the Health Insurance Portability and Accountability Act (HIPAA) of 1996, which requires U.S.-based health care providers, and medical claims processors and payors to transmit medical information, including claims and other transactions, using a set of common EDI standards. It is preferred that secure network connections and security protocols be used to protect patient-identifying information. It will be appreciated that in some embodiments of the system dedicated computer terminals may be used to conduct communications. All such alternative embodiments are within the scope of the present invention.

Using the system of the present invention, practitioners and other participants may share information through a relational database. From the perspective of the individual user, the system 100 may create an individualized interaction for each user. An individual user can download a relational database using mobile devices such as cell phones, etc.

In use, as depicted in box D, a practitioner, such as a doctor, starts using the system by logging on to the computer based system 100 by selecting an appropriate command, such as by clicking a button on a webpage-like interface and entering a username and password on a remote computer 50. The practitioner is then allowed to access data in the relational database 100. This data may be accessed through a “top page” or main page interface, which may be a webpage-like interface which allows the execution of commands to display data from the database in other webpage-like interfaces. The webpage-like interfaces may be created using CSS (Cascading Style Sheet), HTML (Hyper Text Markup Language), SQL (Structured Query Language), PHP (Personal Home Pages), or other programming languages as known to those of ordinary skill in the art.

Similarly, as depicted at box S and box N of FIG. 2, other users, such as social workers or nurses, may start using the system by logging on to the computer based system 100 by selecting an appropriate command, such as by clicking a button on a webpage-like interface and entering a username and password. These users are then allowed to access data in the relational database 100. This data may be accessed through a “top page”, which allows the execution of commands to display data from the database in other webpage-like interfaces. Please note that in FIG. 2, information retrieved from the system 100 is indicated by arrows leading from the system 101 to the particular user D, N, or S, and information entered into the system 100 is indicated by arrows leading from the user D, N, or S to the database 101.

It will be appreciated that customized “top pages” may be created for each individual user, reflecting the interactions that each user may typically have with the system and allowing for faster access to relevant portions of the database. For example, a doctor may be provided with a series of links to community resources, or to a listing of community nurses on call in the doctor's geographic area.

Other information provided on a top page for a practitioner may include a “link” that is created by the software of the present invention to allow the practitioner to “search” the relational database for information provided by other users, such as particular nurses and social workers. A practitioner will be able to search the database 101 for personal information 102 of nurses on call, social workers and patient information, and for available resource information 104 such as information on community hospitals and so forth. This top page may include a link to an interface that allows the practitioner to provide feedback 106 on how computer based system 100 is performing and what can be done to improve the system.

Information on available resources 104, such as community and other resources may be made available to the practitioners through the computer based system 100. These resources 104 may include information necessary to make referrals to legal services, community support services, or other information. The database 100 may contain information on possible and cost-effective resources, alternatives and solutions, making appropriate referrals to categories of medical professionals such as gerontologists, mental health services, specialists, rehabilitation therapists, balance centers, home safety assessment, adaptive equipment, PERS, hospice, etc., as well as information to make appropriate referrals to financial services such as Medicaid qualification services, and to advise the patient and assist them in determining suitability for such services. Where appropriate, information on other available community resources, such as Aging Services programs; including Meals on Wheels, Senior Centers, National Family Caregiver Support Programs, Medicaid waiver programs, subsidized housing, transportation services, Medicare/Medicaid questions, etc., and other resources to community resources; such as the Alzheimer's Association, support groups, adult day programs, respite care, faith communities, and so forth may be provided.

In applications of the system for the United Kingdom, information on district nursing, such as nurses available at various times, and other resources 104, such as the availability of community hospital resources, social worker availability and geographic regions of responsibility, and the availability of crisis centers, such as houses of refuge may be made available in the database 101.

Other examples of information made available on a “top page” interface may include options for updating the information maintained in the database 101. As depicted in FIG. 2, once a user such as a social worker or nurse has logged in (as shown in boxes S and N), the user may add and update information into the database 101. It is currently preferred that practitioners also be provided with the ability to update or add certain information as well. For example, a top page interface may include drop-down menus allowing the user to add and update information in the database 101. In some embodiments, a text field created on the interface may allow users to enter information through a browser that is added to the database 101 via a remote network connection, in addition to pull-down menus.

The interface may be specifically designed or contain specific items allowing the addition or alteration of information based on the user's identification as a practitioner, social worker, nurse or other service provider. That is, a hierarchy of users may be provided that allows doctors, for example, to make changes to patient information that would not be allowed by a nurse or social worker, such as patient diagnosis information. Likewise, certain fields in the database may only be modified by a particular class or type of user depending upon the type of information to be entered into that field. Thus, each user may be assigned a unique identification number that will be generated by the system upon initial registration, allowing tracking and identification of such access. For example, a nurse working through a district nursing program may routinely update the availability of district nursing services, including the geographic regions for which service is available, the identity of available nurses or other relevant information. Similarly, a social worker may periodically update the contact information and availability of various social or community services. A practitioner may update clinical information.

In some embodiments of the system 100, the system may create individual records that are maintained in the database 101 for patients or other individuals treated by a user. Such a file could contain clinical diagnoses or the potential need for, or receipt of, various services. Information from that individual record may be made available to other users in order to facilitate the provision of multiple services to the individual. The specific information made available through the system to each user may be limited as required, by law or otherwise, to maintain appropriate privacy for the individual.

The computer based system 100 and database 101 are preferred to update in real-time as the various users interact with the system. At periodic times, such as a regular interval (e.g., daily, weekly, monthly, etc.), the data present in the system may be recorded by “backing up” the database. This may be accomplished by creating a copy of the entire database 101. Such a copy may be recorded on any computer readable media, as may be appropriate for the implementation of the computer system 100.

By using the system to update and maintain information in real-time, available medical, social and community resources may be allocated appropriately and efficiently by the users of the system 100. This may result in decreased costs for treatment of individual patients and for the health care system as a whole. Records of available services may be updated and stored in the database 101 and accessed from multiple locations. Archival copies of the database may be analyzed over time to provide statistical data on the availability and effectiveness of medical and social services in the served geographic area. Clinical diagnoses and other data may be used for epidemiological analysis.

By analyzing a system in accordance with the present invention, a health care system may improve health care services by sharing data across provider boundaries. This will allow the system to improve services by ensuring the appropriate professional attends to a patient's individual needs and providing real-time information about the patient, care givers and available resources. The system 100 may enhance an administrator's ability to examine trends in the allocation and utilization of district nurses, social workers, doctors and any other health care provider in order to provide adequate staffing and staff availability. This information is valuable for both recruitment and retention of employees. The system 100 may also ensure that reliable data is available for doctors, nurses and social workers and provide data for statistical analysis. The system 100 of the present invention may be implemented over a larger geographic area (such as U.S. a state or a group of counties in the U.K.) data from different geographic areas may be synthesized allowing the examination of trends from across the areas to aid in strategic decision making on many levels.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A process for maintaining a relational database of ancillary health care service information, the method comprising:
providing a relational database containing information on ancillary health care services on a first computer;
updating the information on ancillary medical services in the relational database by a first set of identified users;
saving the updated information in the relational database; and
accessing the relational database to obtain updated health care service information by a second set of identified users.

2. The process according to claim 1, wherein the first computer comprises a network server in operative connection to a computer network.

3. The process according to claim 2, wherein the first set of identified users comprises nurses or social workers.

4. The process according to claim 2, wherein the first set of identified users accesses the first computer by a login procedure after making a network connection to the first computer from a remote computer.

5. The process according to claim 4, wherein the first computer communicates with the remote computer by exchanging information therewith utilizing a hypertext transfer protocol.

6. The process according to claim 2, wherein updating the information on ancillary medical services in the relational database by a first set of identified users comprises allowing the first set of users to enter or revise information on available community resources.

7. The process according to claim 6, wherein allowing the first set of users to enter information on available community resources comprises allowing the users to enter information regarding Aging Services programs, Meals on Wheels, Senior Centers, National Family Caregiver Support Programs, Medicaid waiver programs, subsidized housing, transportation services, the Alzheimer's Association, support groups, adult day programs, respite care, and faith communities.

8. The process according to claim 6, wherein allowing the first set of users to enter information on available community resources comprises allowing the users to enter information on district nursing resources, the availability of community hospital resources, social worker availability and geographic regions of responsibility, or the availability of crisis centers.

9. The process according to claim 2, wherein the second set of identified users comprises Family Practice Doctors, General Practitioners, Nurse Practitioners, or Physician's Assistants.

10. The process according to claim 2, wherein the second set of identified users accesses the first computer by a login procedure after making a network connection to the first computer from a remote computer.

11. The process according to claim 10, wherein the first computer communicates with the remote computer by exchanging information therewith utilizing a hypertext transfer protocol.

12. The process according to claim 1, further comprising making archival copies of the database on a periodic basis.

13. The process according to claim 12, further comprising performing comparative data analysis on the archival copies of the database.

14. A system for providing current information on ancillary support services for individuals with medical needs to health care practitioners, the system comprising:
a first computer containing an updatable relational database containing information on ancillary support services for individuals with medical needs, the first computer configured to allow a first set of identified users to revise the relational database;
at least one accessing computer in communicative contact with the first computer, whereby a set of identified health care practitioners may access the relational database to obtain information on ancillary support services for individuals with medical needs through said at least one accessing computer.

15. The system of claim 14, wherein the first computer comprises a network server.

16. The system of claim 15, process according to claim 2, wherein the first set of identified users comprise nurses or social workers.

17. The system of claim 15, wherein the first set of identified users access the first computer by a login procedure after making a network connection to the first computer from one or more remote computers.

18. The system of claim 17, wherein the first computer communicates with the remote computer by exchanging information therewith utilizing a hypertext transfer protocol.

19. The system of claim 14, wherein information on ancillary support services for individuals with medical needs comprises information regarding Aging Services programs, Meals on Wheels, Senior Centers, National Family Caregiver Support Programs, Medicaid waiver programs, subsidized housing, transportation services, the Alzheimer's Association, support groups, adult day programs, respite care, and faith communities.

20. The system of claim 14, wherein information on ancillary support services for individuals with medical needs comprises information on district nursing resources, the availability of community hospital resources, social worker availability and geographic regions of responsibility, or the availability of crisis centers.

21. The system of claim 14, wherein the set of identified health care practitioners comprise Family Practice Doctors, General Practitioners, Nurse Practitioners, Physician's Assistants, or combinations thereof.

22. The system of claim 14, wherein the first computer communicates with the at least one accessing computer by exchanging information therewith utilizing a hypertext transfer protocol.

23. The system of claim 14, wherein the at least one accessing computer comprises two or more accessing computers disposed at two or more locations.
